(19) United States
(12) Patent Application Publication
(10) Pub. No.: US 2015/0234995 A1
(43) Pub. Date: Aug. 20, 2015

(54) REAL-TIME RECALL INVENTORY MATCHING SYSTEM

(71) Applicants: Peter CASADY, Schaumburg, IL (US); Jim SIPE, Phoenix, AZ (US)

(72) Inventors: Peter CASADY, Schaumburg, IL (US); Jim SIPE, Phoenix, AZ (US)

(21) Appl. No.: 14/704,210

(22) Filed: May 5, 2015

Related U.S. Application Data
(63) Continuation-in-part of application No. 14/495,463, filed on Sep. 24, 2014.
Application No. 14/495,463 is a continuation-in-part of application No. 13/763,977, filed on Feb. 11, 2013, now abandoned.
(60) Provisional application No. 61/603,045, filed on Feb. 24, 2012.

(51) Int. Cl. G06F 19/00; G06Q 30/00

(52) U.S. Cl. CPC G06F 19/3412; G06Q 30/014

(57) ABSTRACT

A health care network system for reducing the instances of errors during a medical procedure may include a data processing system connected to a subscriber system. The subscriber system may include one or more portable data collection devices that are configured to collect and send to the data processing system production identifier data regarding a designated medical device. The data processing system returns information regarding whether an the designated medical device is the subject of an issued recall as well as other characteristics of the designated medical device for verification by a health care professional.

### CROSS REFERENCE TO RELATED APPLICATION

This application is a continuation-in-part of U.S. patent application Ser. No. 14/495,463, filed 24 Sep. 2014, which is a continuation-in-part of U.S. patent application Ser. No. 13/763,977, filed 11 Feb. 2013, which claims the benefit of U.S. Provisional Patent Application Ser. No. 61/603,045, filed on 24 Feb. 2012. These related patent applications are hereby incorporated by referenced herein in their entireties and are made a part hereof, including but not limited to those portions which specifically appear hereinafter.

### BACKGROUND OF THE INVENTION

1. Field of the Invention

This invention is directed to a system for using and managing information regarding medical devices by a health care facility. The use and management of the information may be used to reduce the instances of errors during medical procedures, including a system and method for storing, managing and alerting health care facilities of a product recall for medical devices.

2. Discussion of Related Art

Currently, the most common process for managing inventory and other information for medical devices in a health care facility involves healthcare personnel checking written or electronic health records (ERR) one at a time to determine if a recalled device may have been used in patient care or is currently in facility inventory. This process can take a long time to complete and is subject to possible error. In addition, this process does not allow a health care provider to determine in real-time the products in its inventory that may be subject to recalls. Furthermore, the known processes are limited in that at the point of use (i.e., an operating room or other implantation site) the status of medical devices and any recalls that may have been issued for a medical device are unknown to the health care provider.

Current known processes are unacceptable to health care providers because recalled medical devices may be implanted or be otherwise unknown and used in medical procedures. Such occurrences require immediate, and often costly, remediation actions by the health care provider in order to ensure patient health.

Known methods and systems for managing medical device recalls also fail to automatically notify a healthcare provider if a newly accepted medical device was previously recalled.

Accordingly, there is a need for an improved system for managing recalls of medical devices.

### SUMMARY OF THE INVENTION

A general object of the invention is to provide a real-time process to automatically match medical device recall information to a healthcare provider's inventory and records to alert healthcare personnel of the recall.

Embodiments of this invention include a method tier automatically managing recall information. The method comprises providing an inventory matching system, the inventory matching system comprising a server data processor in communication with a database; automatically receiving recall information for a plurality of medical products from each of a plurality of recall server data processors; and automatically populating the database with the recall information. The method desirably also includes communication with a subscriber. For example, the server data processor receives an inventory product identifier, the inventory product identifier sent from a subscriber server data processor, and the server data processor comparing the inventory product identifier with the recall information to automatically determine if the inventory product identifier matches any of the recall information.

The invention further includes a method comprising: providing an inventory matching system, the inventory matching system comprising a server data processor in communication with a database; automatically receiving from a plurality of remote server data processors recall information of medical devices; automatically populating the database with the recall information; providing a connection between the server data processor and a healthcare subscriber data processor system, the healthcare subscriber data processor system having a healthcare database including identifiers of products in inventory and/or implemented in patients; periodically automatically receiving with the server data processor a list of the identifiers of products from the healthcare subscriber data processor system; the server data processor automatically comparing the list of the identifiers of products with the recall information to automatically determine if any identifier of the list of the identifiers of products matches any of the recall information; and automatically alerting the healthcare subscriber data processor system when at least one identifier of the list of the identifiers of products matches any of the recall information.

Another embodiment of the invention provides a health care network system for reducing the instances of errors during medical procedures. The health care network system includes a data processing system comprising a recall database, a processor and a transceiver. A subscriber system is also included that is connected to the data processing system via the transceiver and further includes one or more portable data collection devices. The portable data collection devices are configured and connected to the subscriber system to collect production identifier data regarding a designated medical device at a site of a medical procedure. The data processing system receives the production identifier data from the subscriber system and determines in real-time whether the designated medical device is the subject of an issued recall and sends information regarding the issued recall to the subscriber system at the site of a medical procedure. The data processing system may also send other characteristics of the designated medical device to the subscriber system at the site of the medical procedure for verification by a heath care professional.

The real-time recall inventory matching system of this invention provides visibility of recalled inventory that is currently within a facility, reducing the likelihood of future use of those devices in patient care. The system also identifies patients that may have been exposed to the recalled device in the past allowing a healthcare provider to take corrective action. The system of this invention also prevents the healthcare provider from accepting a previously recalled device, with or without prior history in the healthcare facility, into a healthcare facility, such as a hospital. In a preferred embodiment of this invention, the system alerts the healthcare provider with a visual alert within a subscriber-based system as well as with an e-mail to an authorized user of the healthcare provider with the details of the recall, including patients that may have been affected and a report or summary of current inventory status of devices still in the facility.

Suppliers and manufacturers of medical devices currently have no visibility at the healthcare facility level when one of their recalled products remains in inventory or has been used in patient care. The suppliers and manufacturers currently rely on hospitals and other healthcare providers to do this research for them. The system of this invention allows suppliers and manufacturers, as well as subscribers and other groups, to generate report of recalls, usage, inventory and patient outcomes, thereby providing greater visibility into product performance.

### BRIEF DESCRIPTION OF THE DRAWINGS

These and other objects and features of this invention will be better understood from the following detailed description taken in conjunction with the drawings, wherein:

FIG. 1 is a representation of a system for automatically managing recall information according to one embodiment of this invention.

FIG. 2 is a flow chart for a method for automatically managing recall information according to one embodiment of this invention.

FIG. 3 is a flow chart for a method for adding a subscriber system to the system of FIG. 1.

FIG. 4 is a flow chart for adding and/or editing a supplier identifier to the system of FIG. 1.

FIG. 5 is a flow chart for adding and/or editing a device identifier to the system of FIG. 1.

FIG. 6 is a flow chart for adding and/or editing a production identifier to the system of FIG. 1.

FIG. 7 is a flow chart for adding a recall to the system of FIG. 1.

FIG. 8 is a flow chart for alerting a user of the subscriber system according to one embodiment of the present disclosure.

FIG. 9 is a flow chart for storing and generating reports from the system of FIG. 1.

FIG. 10 is a flow chart for a process for a global subscriber to generate an aggregate data report from the system of FIG. 1.

FIG. 11 is a flow chart for a process for a supplier subscriber to generate an aggregate data report from the system of FIG. 1.

FIG. 12 is a representation of a health care network system according to one embodiment of the present disclosure.

FIG. 13 is a flow chart according to one example process of the present disclosure.

### DESCRIPTION OF PREFERRED EMBODIMENTS

The present invention provides a system and method for storing and managing product recall information for example, but not limited to, recalls of medical devices. The following description will focus on applying the system and method of this invention to the recall and management of medical devices. However, it should be understood that the system and method of this invention is not limited to the recall of medical devices and may be used to handle recalls of any type of product including, but not limited to, aeronautical parts, automotive parts, toys and food.

The invention includes a real time recall information system that is automatically implemented by a server data processor. This system receives, gathers, stores and interprets product recall information from many sources such as the FDA, manufactures and suppliers, hospitals, etc. The recall information desirably comes by electronic data feed, whereby computer systems, referred to herein as “recall servers” will send the recall information. No human interaction is required. Examples include the FDA, 3rd party recall repositories, suppliers/manufactures, hospitals, etc.

The method and system of this invention are desirably incorporated within a subscriber system that through which subscribers, such as hospitals, can automatically receive recall information for their product inventories, which includes past, present and/or future inventories. Subscribing computer systems send a request with a full listing of medical product data for some or all of its inventory history (active inventory, consumed inventory, in transit inventory, discarded inventory, returned inventory). The product information can include one or more of: manufacturer information (e.g., name, address, phone, fax, supplier number, manufacturer/labeler ID); product codes and/or catalog numbers, lot numbers and/or serial numbers; expiration dates, and manufacture dates.

The request is automatically received electronically using one of many system to system communication standards such as HL7, Web Services, XML Request, RESTful API, etc. The server processor performs a computer algorithm or set of algorithms on this data to loop through each request and process it according to the recall information. This will process each requested medical product item from a subscribing system and determine if there are any matching and applicable recalls in the recall database. Any recall matches will then be associated with their corresponding medical product from the request from the subscribing hospital system. The full result set will be returned to the subscribing hospital system via an electronic data feed response. The subscribing hospital system will then have their initial request data set along with a corresponding recall data point for each recall match and medical device item record. The subscribing hospital system can then determine what to do with those recall matches. The subscribing hospital system can send alerts for recalled items via email and/or SMS text, and/or display recall alerts on a dashboard alert page for hospital staff to see and take action, such as determine and contact past patients, etc. In one embodiment, the subscribing hospital system may include equipment at the site of a medical procedure such that the recall information or other information provided by the system can be verified by health care professionals with the intention to reduce the instances of errors during a medical procedure such as the implantation of a recalled medical device or the use of an incorrect medical device.

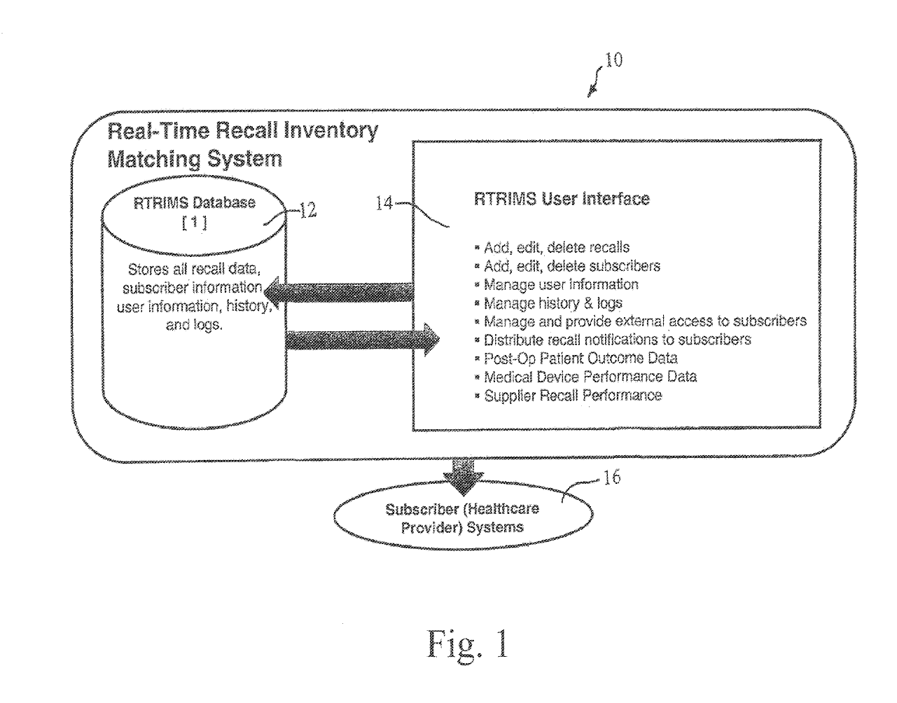

FIG. 1 shows a representation of a Real-Time Recall Inventory Matching System (RTRIM system) 10 according to an embodiment of this invention. The RTRIM system 10 of this invention compares a recall for a medical device to a healthcare provider's inventory and usage history. If the recalled medical device has ever been used in patient care and/or stored in inventory of a medical facility or group of facilities, the RTRIM system 10 alerts the healthcare provider automatically and provides details of the recall.

The RTRIM system 10 preferably includes a RTRIMS database 12 and a RTRIMS user interface 14, in combination with a data processor, and more desirably a server data processor. The RTRIMS database 12 stores information including recall data, subscriber information, user information, history and logs. For example, Table 1 provides a list of recall data stored in the RTRIMS database 10 in one embodiment of this invention.

TABLE 1

Recall Class
Device Class
Date Posted
Recall Number
Product
Description
Code Information
Product Code(s)/Part Number(s)/Reference Number(s)/
Catalog Number(s)
Lot Number(s)/Serial Number(s)/ID Number(s)
Recalling Firm/Supplier/Manufacturer
Supplier Name(s)
Supplier Address
For Additional Information Contact
Reason for Recall
Action
Quantity in Commerce
Distribution
Source of Recall Information
Urgency

However, it should be understood, that the information stored in the RTRIMS database 12 is not limited to the information included in Table 1 and may include additional information including, but not limited to, product identifiers, care instructions, expiration dates, and other information related to the product and/or the recall, such as date of recall, supplier/manufacturer, recall number, code information, consumer instructions, additional information contacts, reason for the recall, action to be taken, quantity in commerce, distribution (country), manufacture and/or expiration date of recalled devices, etc. In some embodiments of this invention, each recall has a line item associated by recall identifier for each recalled item, such as a device identifier and/or production identifier (such as defined in the Unique Device identifier requirements established by the FDA), product code, serial number/lot number/identifier. In preferred embodiments of this invention, the system automatically interprets or otherwise records special cases, such as recall information that is not complete and/or specific and that is meant to be interpreted in some fashion, such as given numerical ranges. For example, a recall may be for a particular product code/catalog number but instead of providing a full list of lot numbers/serial numbers, the system receives a range such as all lot numbers or all lot numbers between xxxx and yyyy. The invention includes one or more algorithms to automatically interpret these vagaries. Exemplary ranges include product code/catalog number ranges, manufacture date ranges, etc.

The RTRIMS user interface 14 allows a user to update and revise the RTRIMS database 12 including: add, edit and delete recalls; add, edit and delete subscribers; manage user information; manage history and logs; manage and provide external access to subscribers; distribute recall notifications to subscribers; post-operation patient outcome data; report medical device performance data; and report supplier recall performance.

The RTRIM system desirably provides a repository of all recalls for medical products that can be subscribed to by any outside computer system. This subscription is desirably automatically implemented between the two or more systems, where RTRIM receives a request electronically using one of many system to system communications standards such as HL7, Web Services, XML Request, RESTful API, etc.

In a preferred embodiment, a subscriber, for example a hospital, acute care facility or other healthcare providers, connects a subscriber system 16, for example a hospital database with product inventory and a history of product usage, to the RTRIM system 10. When a new medical device is entered into inventory and/or usage of the subscriber system 16, the RTRIM system 10 compares the new medical device to the recall information stored in the RTRIMS database 12 to determine if the new medical device has ever been recalled and, if so, issues an alert to the subscriber system 16. Additionally, whenever a new recall is entered into the RTRIMS database 12, the RTRIM system 10 desirably searches inventory and records of the subscriber system 16 to determine if the subscriber system 16 has or has used the newly recalled device, and if so, issues an alert to the subscriber system 16. Preferably, the automated alerts are real-time automated recall alert notifications based on real-time medical device data.

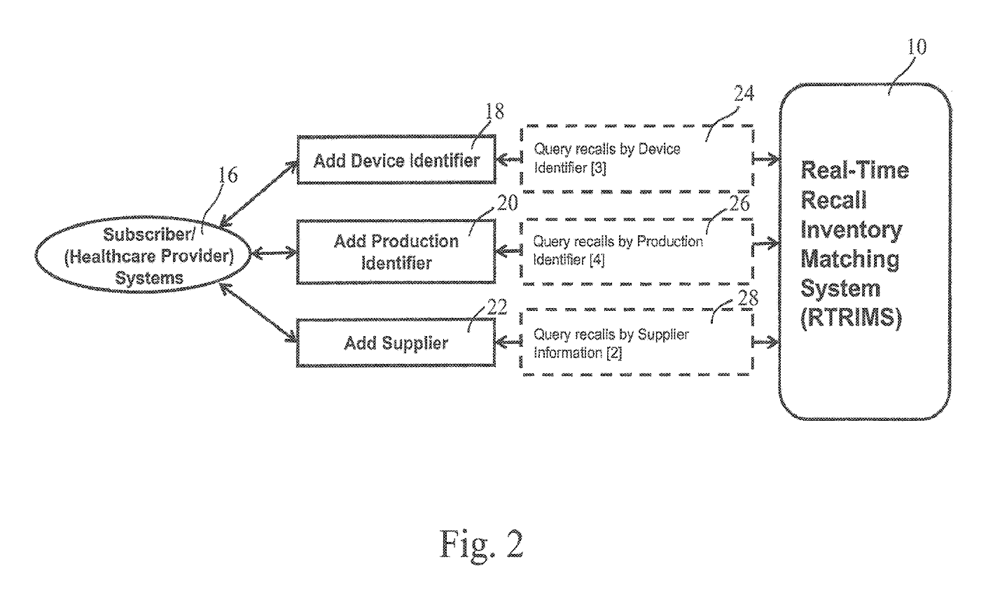

FIG. 2 shows a flowchart overview of a preferred embodiment of the RTRIM system 10 of this invention. The flowchart provides a process to determine if a medical device newly entered into the subscriber system 16 or edited in the subscriber system 16 has been subject to a recall. In this embodiment, the new medical device may be entered into the subscriber system 16 using one or more identifiers, for example, but not limited to, a device identifier 18, a production identifier 20 and a supplier identifier 22. Each of the identifiers 18, 20, 22 at least partially corresponds to the recall data stored in the RTRIMS database 12 so that the RTRIM system 10 can determine if there is match. When one or more identifiers 18, 20, 2.2 is added to or edited in the subscriber system 16; a query 24, 26, 28 will be sent to the RTRIM system 10 to see if there are any applicable recalls. If so, a recall alert will be sent to the subscriber system 16. In an alternative embodiment, any recall data entered into the RTRIM system 10 is automatically sent and stored in each subscriber system 16. With this alternative embodiment, any time one or more identifiers 18, 20, 22 is added or edited to the subscriber system 16, the subscriber system 16 can automatically determine if the product associated with the identifier 18, 20, 22 without querying the RTRIM system 10.

There are several results a subscriber can receive from the RTRIMS system. In one embodiment, the subscriber receives through the subscriber server comprehensive recall data with discovered matches. The subscriber server submits a list of inventory medical products to the RTRIMS system. The list can include any inventory product identifier information, such as medical device history (e.g., manufacture/supplier, product code/catalog number, lot number/serial number info). Using this large data set of information RTRIMS matches each recall to varying levels of detail. For manufacture/supplier information, the system can retrieve all recalls for a specific set of manufactures/suppliers. This is matched based on supplier name, address; phone and/or other identifying characteristics as well as any supplier number or manufacturer/labeler ID as defined by UDI rule, which can be assigned to each supplier by RTRIMS for unique identification.

For product code/catalog numbers information, a list of more specific matches is created based on product code/catalog numbers. Desirably, a subscriber request for product code/catalog number matches the RTRIMS data exactly for product code. In order to increase exact matches, the RTRIMS data may need to be modified or normalized automatically by the system upon receipt from the recall server data servers. Product codes/catalog numbers can be stored in many different ways for the same item. In embodiments of this invention, RTRIMS desirably performs data cleansing to help with the process of matching. As an example, product code/catalog number may be reported to RTRIMS as 1234-AE5 from an FDA recall. RTRIMS will remove all case-sensitivity as well as special characters that are not needed for matching purposes. The resulting code/catalog number will become 1234ae5 for matching purposes. RTRIMS will perform the same data cleansing on all product codes/catalog numbers sent in a request from a subscribing system. In this mariner a product code/catalog number 12-34-Ae5 being sent as a request from a subscribing system to RTRIMS will match 1234ae5 in the RTRIMS recall data base. These methods are also applicable to other identifier information; such as lot number and/or serial numbers.

In another embodiment of this invention, the method includes automatically adding all recall identifiers within a recall range to the database. This happens when the recall data received by RTRIMS includes a range of, for example, product codes/catalog numbers. For example: if the recall is for all product codes from xxxx to yyyy, the RTRIMS will automatically fill in the implied range and provide in the database matches for product codes/catalog numbers included but not specifically mentioned in this range. A recall from the FDA including a product code/catalog number range from 1 to 9 can be automatically interpreted and expanded to be a full range of specific values: 1, 2, 3, 4, 5, 6, 7, 8, 9. Each of these discrete data points from 1 to 9 will be stored or otherwise matched with a product code/catalog number request received from a subscribing system. If automatically adding all recall identifiers within the range to the database from a request from a subscribing system matches one of these interpreted, discrete values RTRIMS will match. In this way the system can provide more matches than if relying simply on exact matches alone.

The system can similarly operate with a range of manufacture and/or expiration dates. RTRIMS will provide recall matches for medical products when there is a specific date range of manufacture and/or expiration provided in the recall info in RTRIMS. This relies on the request from the subscribing system to provide the date of manufacture for medical product(s). A range of dates can automatically be interpreted and applied to the date of manufacture and/or expiration for each medical product manufacture and/or expiration date provided by the subscribing system in its recall request. Examples include exact date of manufacture and/or expiration, date of manufacture and/or expiration BEFORE a specified date, date of manufacture and/or expiration AFTER a specified date, date of manufacture and/or expiration between a START date and an END date as well as others.

In one embodiment of this invention, RTRIMS will provide recall matches for medical devices when there is only a manufacturer or supplier provided by the request from the subscribing system. This is done using a combination of the identifying supplier number in RTRIMS data definition as well as manufacturer/labeler ID as defined by the FDA's Unique Device identification requirements. Manufacturer name, address, phone and other factors are used to match a supplier based on this metadata. This assumes that the request from the subscribing system contains additional supplier/manufacturer metadata such as name, address, also known as, parent firm, phone number, fax number, etc., because RTRIMS will use this meta data to compare against a list of supplier data for matching purposes.

Any request by a subscriber system can be returned in the same format as the original request (RTRIMS response will be XML if the request was XML, it will be HL7 if the request was HL7). Added to each record in the request list will be a recall detail which corresponds to the recall match for that specific request entry. The recall detail will contain all relevant recall info as seen in the RTRIMS data definition. This full result set will be sent back to the subscriber system as a response. The subscriber system can then process their original request and find each item that had a recall match.

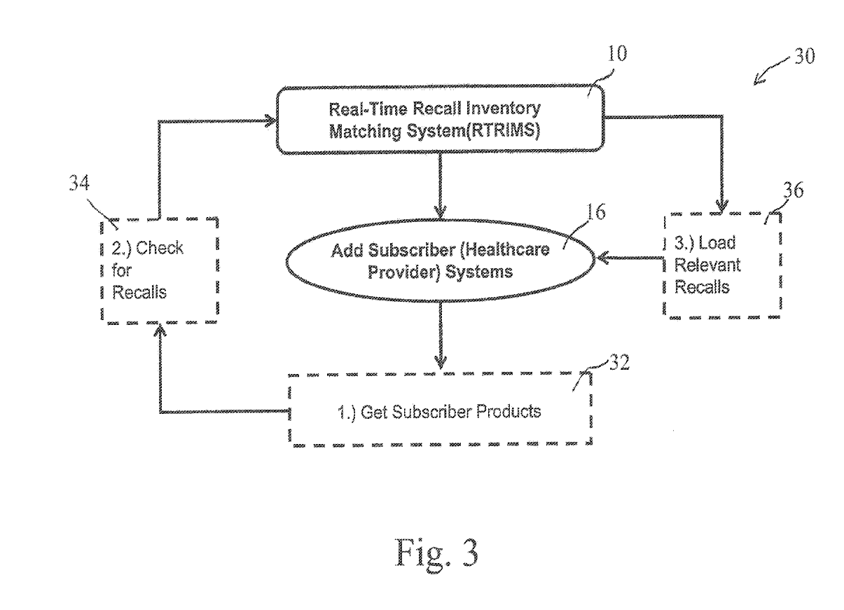

FIG. 3 shows a flow chart for a process 30 for adding the subscriber system 16 to the RTRIM system 10 according to an embodiment of this invention. After the new subscriber system 16 is associated with the RTRIM system 10, the RTRIM system 10 checks the new subscriber's 16 current inventory of medical devices and reports or histories of medical devices used by the new subscriber 16 to get a list of subscriber products 32. The RTRIM system 10 then compares the list of subscriber products to recall information stored in the RTRIMS database 12 to check for recalls 34. If a relevant recall is found, the recall data is sent 36 to the subscriber system 16 and, if appropriate, an alert is displayed on or otherwise transmitted to the subscriber system 16. In an alternative embodiment, all recall data is automatically loaded and saved in the subscriber system 16 to be used to display relevant recall information in a timely matter for all medical devices taken into inventory or used in medical procedures without querying the RTRIMS database 12. The new subscriber 16 will also be set up in the RTRIM system 10 to receive real-time alerts on an on-going basis for the duration of a subscription.

The invention is flexible and can service different levels of subscribers. Single request subscribers can send a list of medical product information to get recall matches for at least one medical product. Each medical product in the list includes one or more of manufacture/supplier name/number/identifier, product code/catalog number, lot number/serial number, expiration date, date of manufacture. RTRIMS will automatically receive the request and automatically send matches based on the above methods. The data may not be stored in the RTRIMS system for this type of request. An example of a single request subscriber could be a user that enters a product code/catalog number and a lot number/serial number into a search window. The user will submit the request to RTRIMS to look up recall matches for this particular medical product. RTRIMS will send back a notification of any matches, and if there are matches specific recall information will be returned.

For recurring/long term subscriptions, subscribers can similarly send a list of medical product information to get recall matches, and RTRIMS can receive this list and store it for the period of service of the subscriber. RTRIMS will automatically run its matching method on this list and return any matching results to the subscriber system upon receipt and upon receiving any future matching recall information. An example of a simple recurring/long term subscriber is a user that is interested in recalls for a medical device implant. The subscriber will sign up for a period of service with RTRIMS and enter their specific medical device information (including but not limited to: manufacturer/supplier name/number/identifier, product code/catalog number, lot number/serial number, expiration date, date of manufacture, etc.). The subscriber will also enter their preferred method of response: email, SMS text, HL7 message, XML message, Web Service response, etc. RTRIMS will store this user's service length, medical device information and preferred method of response. When new recall information is received by RTRIMS it will be run against stored lists and all recurring/long term subscriber data and RTRIMS will return results to each subscriber's preferred response method.

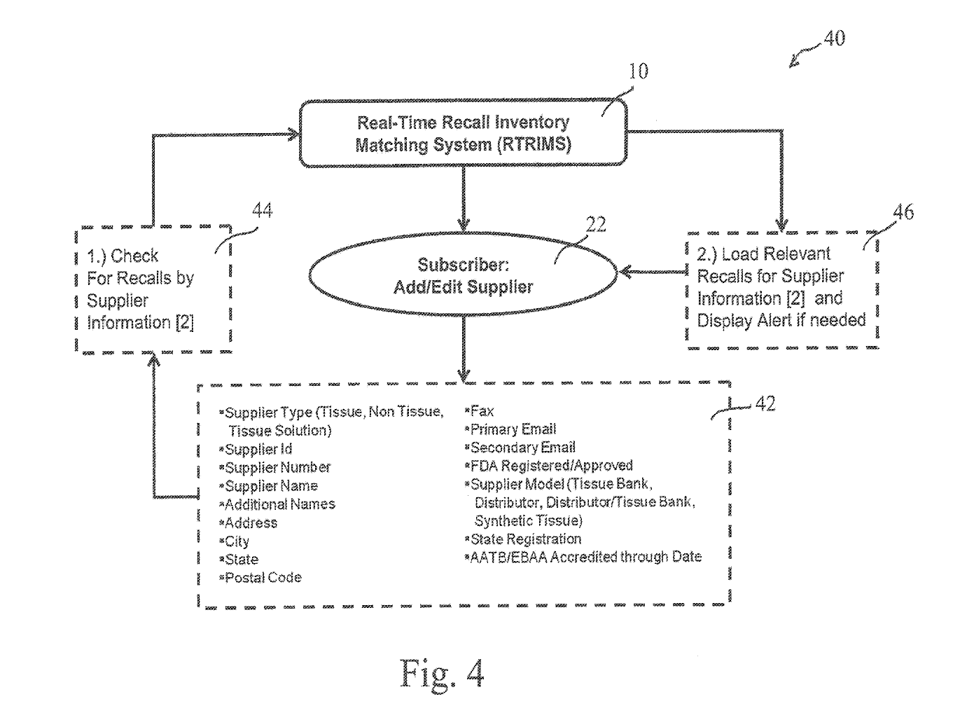

FIG. 4 is a flow chart for a process 40 for adding a new product or editing an existing product to the subscriber system 16 with the supplier identifier 22. In an embodiment of this invention, data of the supplier identifier 22 may include, but not limited to, information shown on Table 2.

TABLE 2

Supplier ID/Supplier Number
Supplier Name(s)
Supplier Address
Supplier Type (tissue, non-tissue, tissue solution)
Facsimile Number
E-mail
FDA Registered/Approved
Supplier Model (Tissue Bank, Distributor, Distributor/Tissue Bank,
Synthetic
Tissue)
State Registration
AATB/EBAA Accredited Through Date

After the supplier identifier 22 is added or edited 42 to the subscriber system 16, a query 44 is sent to the RTRIM system 10 to check for recalls associated supplier identifier 22. If the RTRIM system 10 determines that there are relevant recalls, the RTRIM system 10 loads the relevant recalls 46 to the subscriber system 16 and, if appropriate, an alert is displayed on the subscriber system 46. In another embodiment, the real-time alert is electronically transmitted to an appropriate representative of the subscriber system 16.

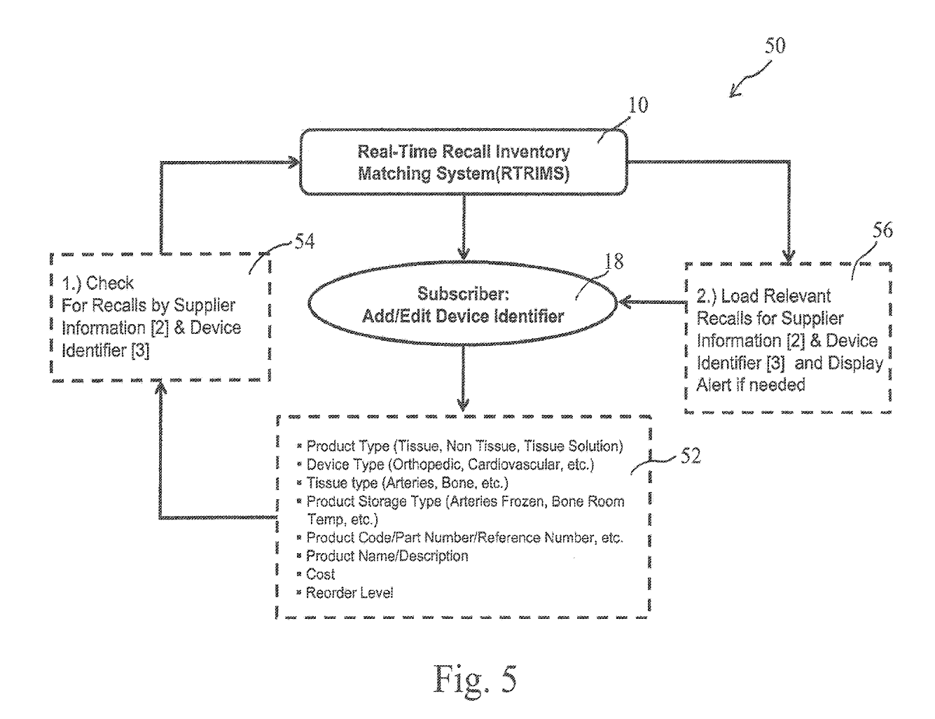

FIG. 5 is a flowchart 50 for adding and/or editing the device identifier 18 of the subscriber system 16. In an embodiment of this invention, the device identifier 18 includes information shown in Table 3.

TABLE 3

Device Identifier (static)
Product
Description
Code Information
Product Code(s)/Part Number(s)/Reference
Number(s)/Catalog Number(s)
Product Type (Tissue, Non Tissue, Tissue Solution)
Device Type (Orthopedic, Cardiovascular, etc.)
Tissue Type (Arteries, Bone, etc.)
Product Storage Type (Arteries Frozen, Bone Room Temp., etc.)
Cost
Reorder Level

In a preferred embodiment of this invention, when a device identified by the device identifier 18 is added to or edited 52 in the subscriber system 16, a query 54 is sent to the RTRIM system 10 to check for recalls associated with the supplier identifier 22, Table 2, and the device identifier 18, Table 3. If the RTRIM system 10 determines that the newly entered or edited device has been subject to a recall, the RTRIM system 10 loads relevant recalls to the subscriber system and, if needed, sends an alert to the subscriber system 16 by displaying the alert on the subscriber system 16. Alternatively, the RTRIM system 10 may send an alert by e-mail and/or another electronic notification system including but not limited to a text message and an automated phone call.

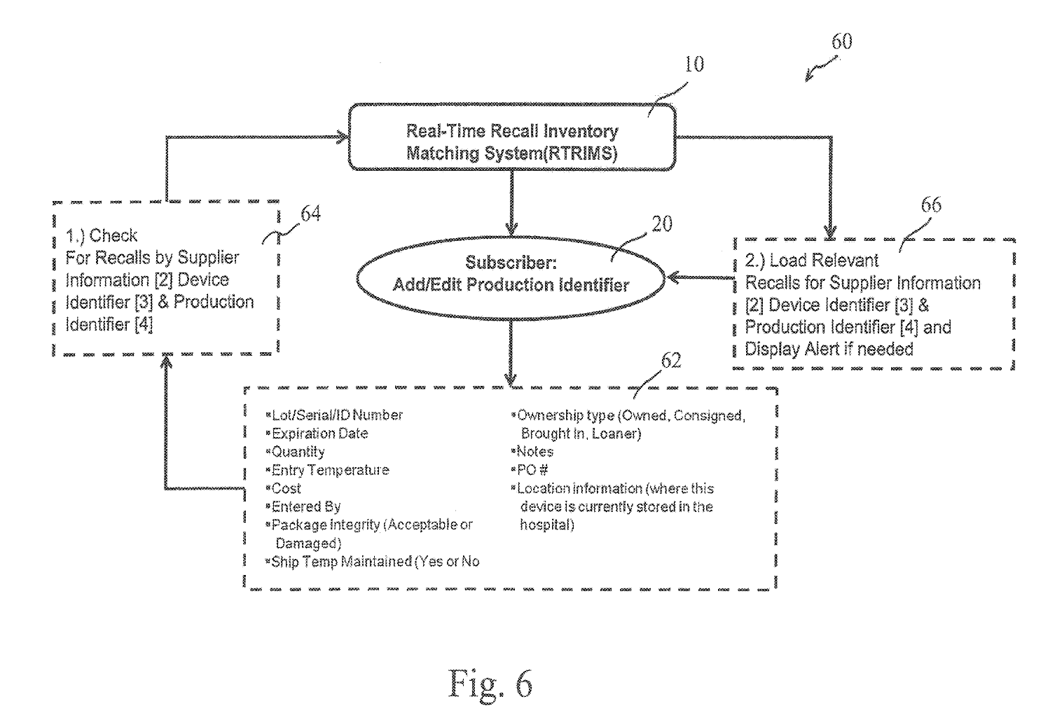

FIG. 6 is a flowchart 60 for adding or editing a device to the subscriber system with the production identifier 20. In an embodiment of this invention, the production identifier 20 may include information shown in Table 4.

TABLE 4

Production Identifier (dynamic)
Code information
Lot Number(s)/Serial Number(s)/ID Number(s)
Expiration Date
Quantity
Entry Temperature
Cost
Entered By
Package Integrity (Acceptable or Damaged)
Ship Temp Maintained (Yes or No)
Ownership Type (Owned, Consigned, Brought In, Loaner)
Notes
PO #
Location Information (where this device is currently stored in
the hospital)

In a preferred embodiment of this invention, when a device with the production identifier 20 is added to or edited 62 in the subscriber system 16, a query 64 is sent to the RTRIM system 10 for recalls associated with the device identified in at least one of the supplier identifier 22, Table 2, the device identifier 18, in Table 3, and the production identifier 20, Table 4. If a relevant recall is found, the RTRIM system 10 sends a real-time alert to the subscriber system 16. Alternatively, the RTRIM system 10 may send an alert by e-mail and/or another electronic notification system including but not limited to a text message and an automated phone call.

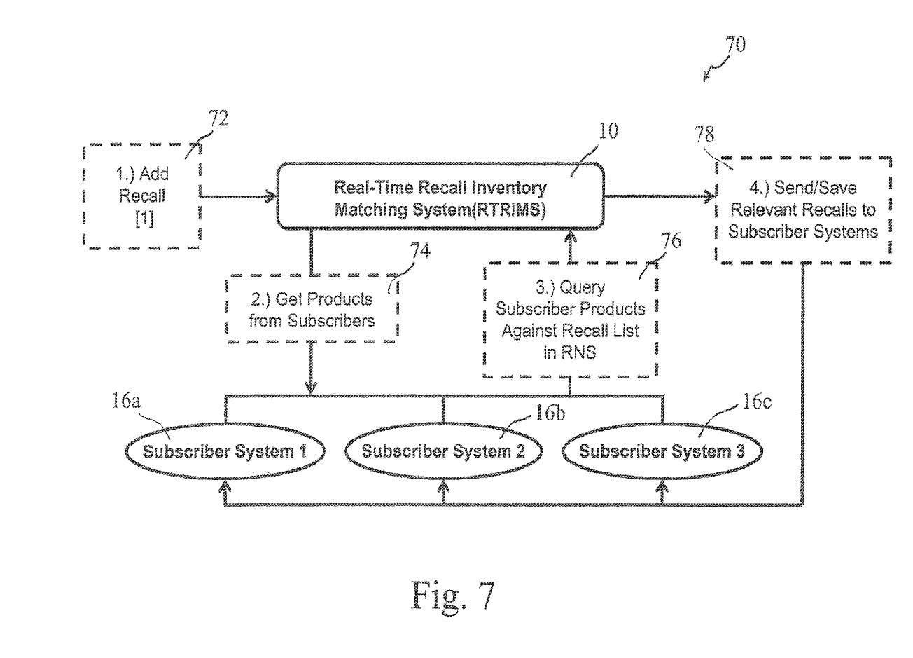

FIG. 7 is a flow chart for a process 70 for adding a new product recall to the RTRIM system 10 according to a preferred embodiment of this invention. The process 70 starts by entering a product recall 72 to the RTRIM system 10. Preferably, the product recall 72 includes at least one of a recall device identifier, a recall production identifier and a recall supplier identifier. In an embodiment of this invention, the product recall 72 may be entered into the RTRIM system 10 with the RTRIMS user interface 14. Alternatively, the new product recall may be transferred to the RTRIM system 10 from a manufacturer or supplier of the recalled product. After the new product recall is added to the RTRIM system 10, the RTRIM system 10 gets a list of products 74 currently in inventory and products used in procedures from each of the plurality of subscriber systems 16a, 16b, 16c. The RTRIM system 10 the compares 76 the list of products from each of the subscriber systems 16a, 16b, 16c to determine if any of the subscriber systems have current inventory or product history related to the new product recall. If a match is found, an alert is sent to the appropriate subscriber system 16a, 16b, 16c. In a preferred embodiment, the RTRIM system 10 also sends the alert to the subscriber system 16 by e-mail and/or another electronic notification system including but not limited to a text message and an automated phone call.

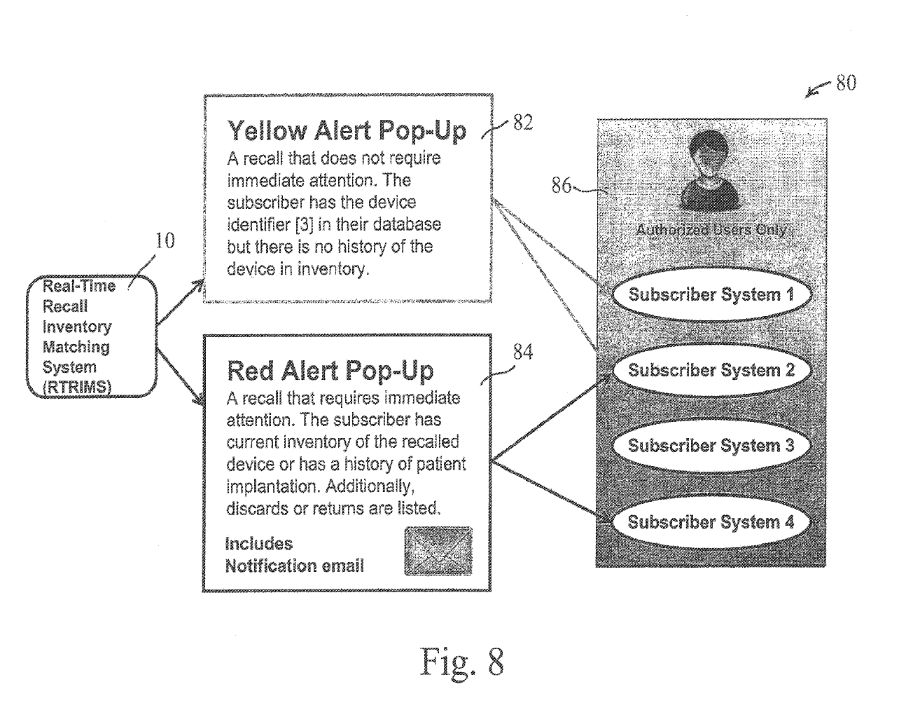

In a preferred embodiment of this invention, the alert system comprises a two-tiered alert notification system 80 for providing real-time recall notifications to the subscriber systems 16. FIG. 8 shows a preferred embodiment of the two-tiered alert notification system 80 of this invention. When the RTRIM system 10 determines a recall notification is applicable to a medical device in the subscriber system's 16 inventory or records, the RTRIM 10 system sends out a real-time recall notification 82, 84 notifying the subscriber system 16 of the recalled medical device. The system 10 includes two types recall notifications, a yellow alert 82 and a red alert 84. In an alternative embodiment of this invention, the alert system may comprise a single tier system or a multiple-tiered system with or without three or more color codes. In the embodiment of FIG. 8, the yellow alert 82 alerts the subscriber system 16 of a recall that does not require immediate attention, for example, when the recalled medical device's identifier matches one of the identifiers 18, 20, 22 stored in the subscriber system 16 but the recalled medical device is not located in the subscriber system's inventory and the recalled medical device has not been used in a procedure. The red alert 84 alerts the subscriber system 16 of a recalled medical device that requires immediate attention. For example, when the recalled medical device's identifier matches one of the identifiers 18, 20, 22 for a device currently stored in the subscriber's inventory or previously used by the subscriber, the RTRIM system 10 will send the red alert 84. In a preferred embodiment, the alerts 82, 84 are displayed with a pop-up alert on a display in the subscriber system 16. The alerts 82, 84 may additionally or alternatively be transmitted to users 86, preferably authorized users, by electronic means, such as, but not limited to, an e-mail notification, a text message notification and an automated phone call. In an embodiment of this invention, the subscriber system 16 must acknowledge notification of the alert 82, 84 and/or indicate that appropriate response has been taken in response to the alert 82, 84.

In a preferred embodiment of this invention, recall notification details are included with the alert 82, 84 and the electronic notification. The recall notification details may include the supplier, the date of the recall and an appropriate action to take in response to the recall. The recall notification details may further include a report of the disposition of all the recalled devices in the subscriber's records. The recalled devices have at least four possible dispositions: used in patient care (e.g. implanted in patient); in current inventory; returned to supplier or manufacturer; or discarded or destroyed.

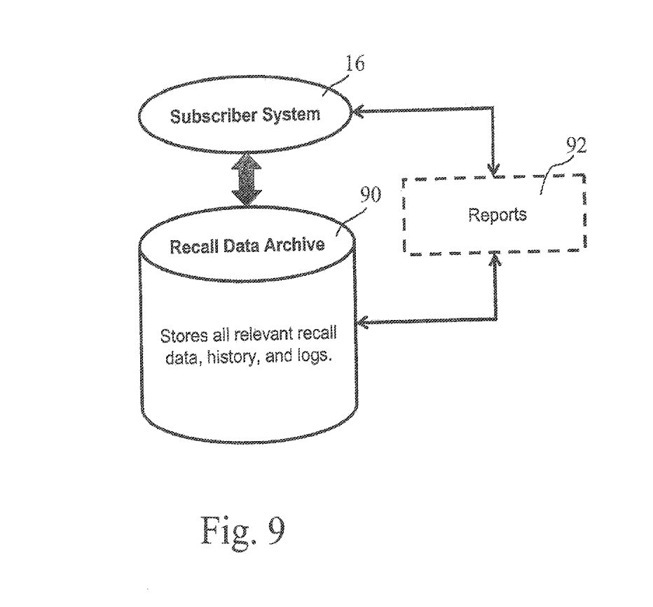

In a preferred embodiment of this invention, as shown in FIG. 9, the system 10 includes a subscriber recall data archive 90 for storing information relevant to each specific subscriber system (healthcare provider) from the recall notification system 10. Preferably, the data stored in the subscriber recall data archive 90 is limited to recall data relevant to devices that the subscriber system 16, has used in patient care, has in current inventory, returned to supplier and/or discarded. The subscriber recall data archive 90 may also store data of specific users who have viewed each recall and whether or not appropriate action has been taken in response to the recall. In a preferred embodiment, a report 92 can be generated from the subscriber recall data archive 90.

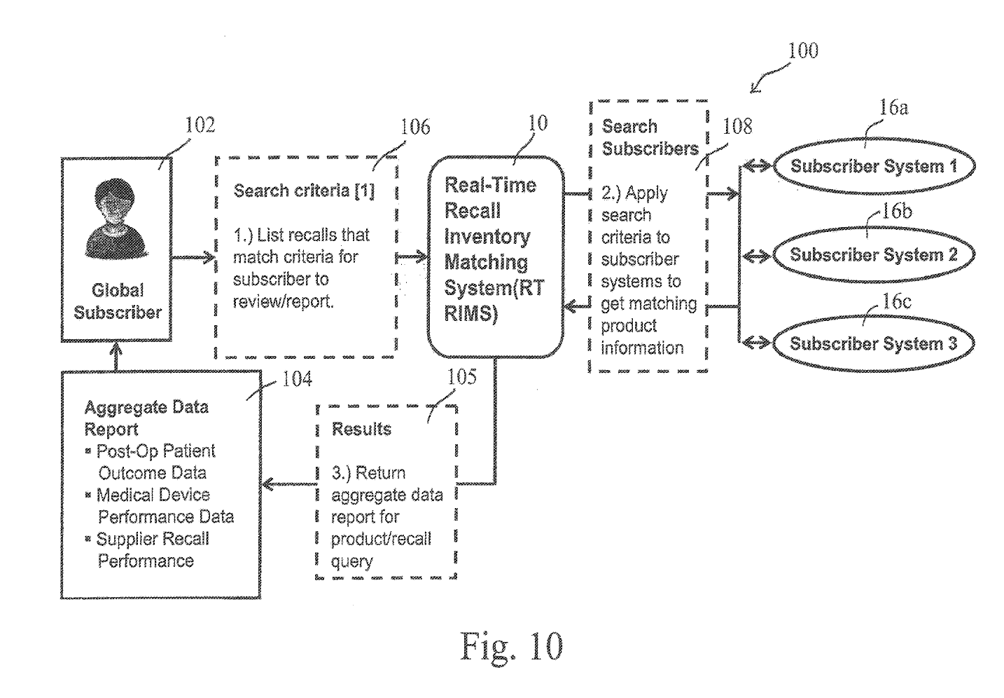

In an embodiment of this invention, the RTRIM system 10 further includes a process 100 for a global subscriber 102 to generate an aggregate data report 104 on a plurality of subscriber systems 16a, 16b, 16c to compile performance data including, but not limited to, post-operation outcome data, medical device performance data, and supplier recall performance. The global subscriber 102 may be any person or group that is interested compiling data on medical devices for studies and journal articles. The global subscriber 102 includes many types of people and groups including, but not limited to, university professors, journalists, lawyers, industry groups and healthcare providers. FIG. 10 is a preferred embodiment of the process 100 for generating aggregate data reports. The process 100 starts with the global subscriber 102 entering search criteria 106 into the RTRIM system 10 including product recalls, post-operation patient outcome, and a supplier's performance. The RTRIM system 10 applies the search criteria to a plurality of subscriber systems 16a, 16b, 16c to gather the desired product information 108. The RTRIM system 10 then returns an aggregate data report 105 to the global subscriber 102 with the results of the query.

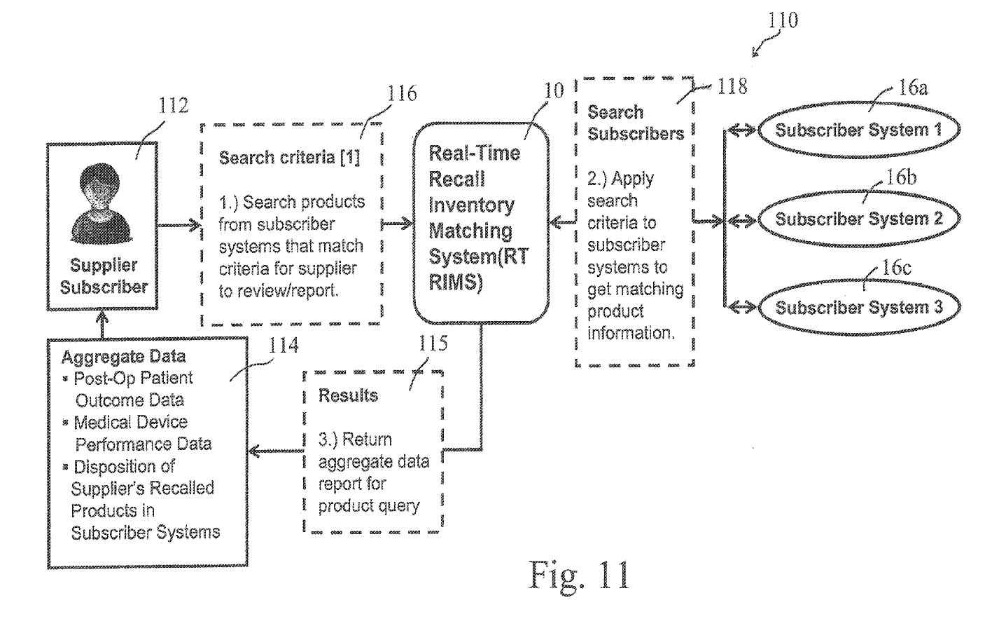

FIG. 11 shows a process 110 for a supplier subscriber 112 to generate an aggregate data report 114 of the supplier's product performance data including, but not limited to, post-operation patient outcome data, medical device performance data, and disposition of the supplier's recalled products in subscriber systems 16a, 16b, 16c. Unlike the global subscriber 102, the process 110 for the supplier subscriber 112 is preferably limited to data related to the supplier subscriber's 112 products. Alternatively, the process 110 may allow the supplier subscriber 112 to obtain reports of other subscribers for a product comparison or another reason. The process 110 starts with the supplier subscriber 112 entering search criteria 116 into the RTRIM system 10. The RTRIM system 10 applies the search criteria to a plurality of subscriber systems 16a, 16b, 16c to gather information on the supplier's products 118, such as performance statistics. The RTRIM system 10 then returns an aggregate report 115 to the supplier subscriber 112.

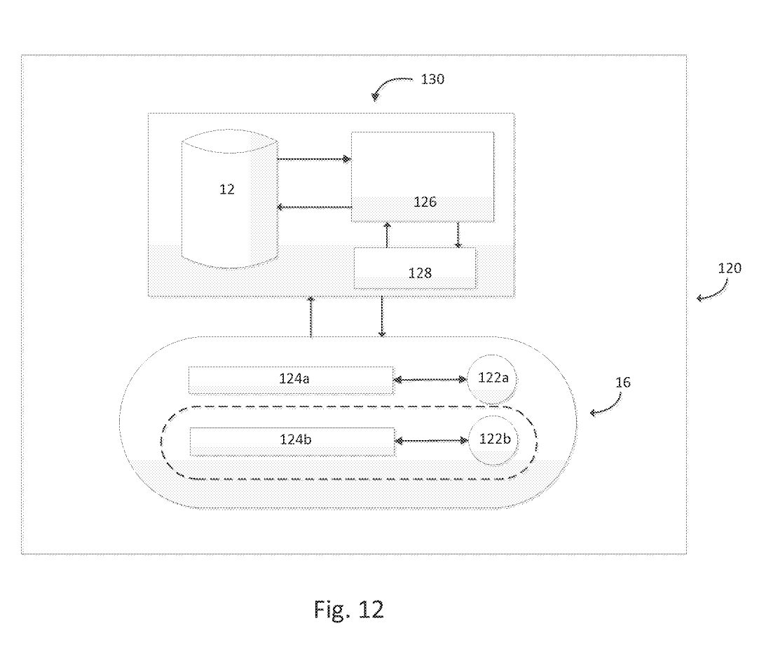

FIG. 12 shows an embodiment of a health care network system 120. Health care network system 120 may include data processing system 130 and subscriber system 16. In this embodiment data processing system 130 may include recall database 12, processor 126 and transceiver 128. Subscriber system 16 may include one or more subscriber processing units 124 and one or more portable data collection units 122. As can be seen, data processing 130 and subscriber system 16 are connected to one another in order to facilitate the exchange of information or data. This communication may occur through one of more suitable communication protocols as previously described.

The one or more subscriber processing units are connected to the one or more complimentary portable data collection units. The subscriber processing unit and complimentary portable data collection unit can be separate pieces of equipment connected via wired or wireless communication systems as shown in FIG. 12 at 124a and 122a. In other embodiments, a subscriber processing unit and a complimentary portable data collection unit can be combined into a single piece of hardware as shown at 124b and 122b and, as a whole, be portable. In either embodiment, the portable data collection unit 122 is connected to a subscriber processing unit and the subscriber system 16 such that the transfer of collected information can be shared. Some examples of subscriber processing units 124 include laptops, tablets, smart phones and the like. Portable data collection units may include cameras, scanners and other hardware integrated into a laptop, tablet or smart phone. Still other examples of portable data collection units 122 may include bar code scanners, stand-alone cameras, and other imaging devices. Other types of subscriber processing units 124 and portable data collection units 122 may also be used, including specialty hardware designed for use in a subscriber system 16, so long as the hardware functions as described herein.

The provision of a portable data collection device 122 permits the collection of production identifier data at a site of a medical procedure. As such, the collection of production identifier data from a medical device chosen for use in a medical procedure (i.e., a designated medical device) can be accomplished at the very site of the medical procedure. For example, the collection of data by a portable data collection device 122 can occur in an operating room. By enabling the use of the systems described herein at the site of the medical procedure, the instances of errors during the medical procedure can be reduced. For example, if a designated medical device is the subject of a new or recently issued recall, this information can be provided to the surgical team in the operating room on a real-time basis to prevent the use or implantation of the recalled device. This type of real-time information collection does not exist in present health care systems.

As discussed earlier, the information stored in data processing system 130 and/or subscriber system 16 may include various types of information regarding medical devices. This information can include expiration date, storage temperature, package integrity and other information relevant to the integrity and safety of a medical device. In other examples of the present disclosure, this information or characteristics of a designated medical device can be provided to a surgical team or other health care professional at the site of a medical procedure so that the health care professional can verify that the correct medical device is being used, has been properly maintained and is appropriate and safe for use in the medical procedure.

The use of one or more portable data collection devices 122 and one or more subscriber processing units at various sites at a health care provider's facility further advances the goal of reducing the instances of errors in medical procedures. Production identifier data can be collected at one or more sites at a health care provider such as inventory receiving, medical device storage, and during the physical movement of medical devices within a health care facility. The existence of portable data collection devices in the disclosed system facilitates the collection of production identifier data and the return of possible relevant recall information to the health care provider. The fact that the health care network system described herein is capable of returning relevant recall or other characteristics of a designated medical device in real time at the time of collection provides instant feedback to the health care professional of information that can lead to removal of an expired medical device from inventory, to removal of a recalled medical device from circulation for quarantine and disposition, or other appropriate remedial actions. With each touchpoint facilitated by a portable data collection device 122 and/or subscriber processing unit 124, the probability of an error occurring during a medical procedure is further reduced.

In one embodiment, portable data collection device 122 requires a health care professional to request collection of the production identifier data from a designated medical device. In other words, a health care professional must take a physical action to collect the production identifier data. Such a physical action may be pressing a button on a portable data collection device 122 or making a verbal command of the device. Other express actions of a health care professional can also be used. This further facilitates the goal of reducing errors in medical procedures because the health care professional's attention is directed to the portable data collection device and/or the subscriber processing unit to receive the real-time information regarding relevant recalls or other relevant characteristics sent via the system. This can be advantageous over a passive system in which periodic reports are sent to a health care provider without the specific request of a health care professional. Periodic reporting or the alerting of remote administrative personnel rather than alerting the local health care professional is less likely to result in immediate remedial action if such remedial action is necessary.

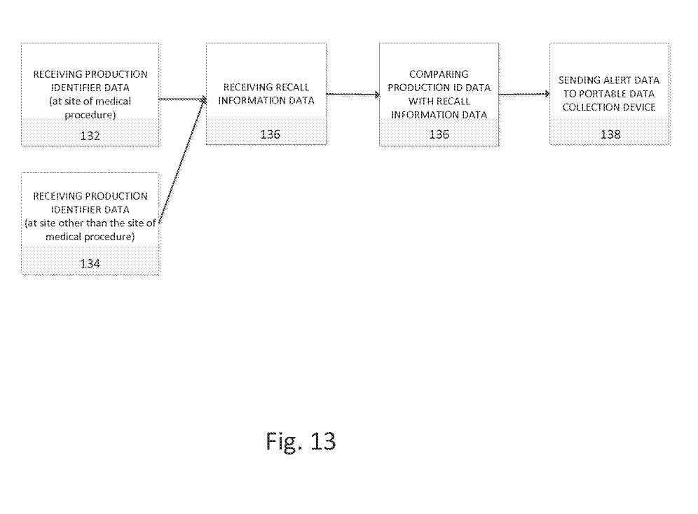

One example method according the present disclosure is shown in FIG. 13. As can be seen, the process can be initiated at step 132 when data processing system 130 receives production identifier data. This production identifier data can be collected and sent from the site of a medical procedure or from other sites within a health care facility as previously described and shown at step 134. At step 136, the data processing system 130 receives recall information from various sources as previously described. This step in the process occurs on an on-going basis. The system collects and stores the recall information and other information so that it is available for use when production identifier data is sent to the data processing system. At step 136, the production identifier data is compared to the recall information data. The data processing system 130 identifies any relevant recalls that may have been issued for the designated medical device for which the production identifier data was collected and sent for processing. At this step, the data processing unit may also collect any other relevant information regarding the designated medical device that may be stored in the database(s). This information may include other characteristics of the designated medical device, such as expiration date, storage history, temperature and the like. At step 138, the data processing system may send alert data to the site where the production identifier data was sent. This may be the site of the medical procedure or other such location where the data collection originally occurred. In addition, this alert data may also be sent to administrative or other locations so that proper records or other verification actions can be taken. The foregoing process may modified or performed in various sequences according the needs of a health care provider.

Thus, the invention provides an improved system and method for automatically matching medical device recall information to a healthcare provider's inventory and records to alert healthcare professionals of actions that should be taken in response to a recall. The systems and methods may also be used to reduce the instances of errors during medical procedures.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

What is claimed is:

1. A health care network system for reducing the instances of errors during a medical procedure comprising:
a data processing system comprising a recall database, a processor and a transceiver; and
a subscriber system connected to the data processing system via the transceiver; the subscriber system including one or more portable data collection devices;
wherein the one or more portable data collection devices is configured and connected to the subscriber system to collect production identifier data regarding a designated medical device at a site of a medical procedure in a health care facility, the data processing system is configured to receive the production identifier data from the subscriber system to determine in real-time whether the designated medical device is the subject of an issued recall and to send information regarding the issued recall to the subscriber system at the site of the medical procedure.

2. The health care network system of claim 1 wherein the data processing system is further configured to send to the subscriber system other characteristics of the designated medical device for verification by a health care provider at the site of the medical procedure.

3. The health care network system of claim 2 further comprising one or more secondary data collection devices connected to the subscriber system configured to collect production identifier data regarding medical devices located in a health care provider's inventory at sites other than the site of the medical procedure in a health care facility, the data processing system further configured to send information regarding an issued recall to the site other than the site of the medical procedure.

4. The health care network system of claim 1 wherein the one or more portable data collection devices is a bar code scanner.

5. The health care network system of claim 1 wherein the portable data collection device automatically collects the production identifier data upon request of a health care professional at the site of the medical procedure.

6. The healthcare network system of claim 1 wherein the portable data collection device is configured to collect the production identifier in multiple formats or through multiple modes of operation.

7. A method of reducing the instances of errors during a medical procedure via a health care network system comprising:
receiving production identifier data regarding a designated medical device from a portable data collection device located at a site of a medical procedure at a health care facility, wherein the production identifier data is collected by the portable data collection device;
receiving recall information data by a data processing system from one or more repositories of recall information;
comparing the production identifier data with the recall information data to determine whether the designated medical device is the subject of a recall;
sending alert data to the site of the medical procedure to prevent use of designated medical device during the medical procedure if a relevant recall is identified.

8. The method of claim 7 wherein the portable data collection device reads the production identifier data by scanning a bar code.

9. The method of claim 7 wherein the portable data collection device is a portable bar code scanner.

10. The method of claim 7 further comprising receiving production identifier data via a subscriber system, wherein the production identifier data is collected at a site other than the site of a medical procedure; and
comparing the production identifier data received via the subscriber system with the recall information to determine whether any of the production identifier data identifies a medical device subject to a recall.

11. The method of claim 10 wherein the production identifier data that is collected at a site other than the site of a medical procedure is collected by a portable bar code scanner.

12. The method of claim 7 further comprising interpreting the recall information data to identify incomplete or non-specific identifiers of medical devices in the recall information data and adding missing medical device data to the recall information data.

13. A medical data processing system for reducing instances of errors during a medical procedure comprising;
a data processing system comprising a recall database, a processor and a transceiver;
wherein the transceiver is connected to a subscriber system at a health care facility, the data processing system configured to receive production identifier data regarding a designated medical device collected by a portable data collection device at a site of a medical procedure at the health care facility and determine in real-time whether the designated medical device is the subject of an issued recall and to send information regarding the issued recall to the subscriber system at the site of the medical procedure.

14. The medical data processing system of claim 13 wherein the data processing system is further configured to send to the subscriber system other characteristics of the designated medical device for verification by a health care provider at the site of the medical procedure.

15. The medical data processing system of claim 14 further comprising one or more secondary data collection devices connected to the subscriber system configured to collect production identifier data regarding medical devices located in a health care provider's inventory at sites other than the site of the medical procedure in a health care facility, the data processing system further configured to send information regarding an issued recall to the site other than the site of the medical procedure.

16. The medical data processing system of claim 13 wherein one of the one or more portable data collection devices is a bar code scanner.

17. The medical data processing system of claim 13 wherein the portable data collection device automatically collects the production identifier data upon request of a health care professional at the site of the medical procedure.

18. The medical data processing system of claim 13 wherein the portable data collection device is configured to collect the production identifier in multiple formats or through multiple modes of operation.
